(19) United States
(12) Patent Application Publication
(10) Pub. No.: US 2013/0067448 A1
(43) Pub. Date: Mar. 14, 2013

(54) APPLICATION DEPLOYMENT

(71) Applicants: Hemchander Venkateshwara Sannidhanam, Bothell, WA (US); John Michael Sheehan, Sammamish, WA (US); Andres Carlo Petralli, Seattle, WA (US); Zainab Hakim, Sammamish, WA (US)

(72) Inventors: Hemchander Venkateshwara Sannidhanam, Bothell, WA (US); John Michael Sheehan, Sammamish, WA (US); Andres Carlo Petralli, Seattle, WA (US); Zainab Hakim, Sammamish, WA (US)

(73) Assignee: Microsoft Corporation, Redmond, WA (US)

(21) Appl. No.: 13/229,397

(22) Filed: Sep. 9, 2011

(51) Int. Cl. G06F 9/445; G06F 9/44

(52) U.S. Cl. 717/169; 717/174

(57) ABSTRACT

One or more techniques and/or systems are provided for deploying an application within a computing environment. In particular, an application that is requested for deployment may be identified (e.g., an application to be downloaded, installed, updated, registered and/or removed during deployment). A set of deployment rules may be executed upon deployment parameters within a manifest (e.g., metadata describing how the application is to be deployed) to detect whether a conflict (e.g., issues that may arise from concurrent deployment) may exist between the deployment parameters and a second application currently being deployed within the computing environment. For example, resource access conflicts, file access conflicts, and/or registry access conflicts may be identified. If no conflicts exist, then the application may be concurrently deployed with the second application. In this way, applications associated with users may be concurrently deployed within the computing environment, while mitigating conflicts to achieve deployment parallelization.

### BACKGROUND

Many computing environments, such as desktop, tablet, and/or mobile phone environments, allow users to deploy software applications within them. In particular, an application may be downloaded, installed, updated, and/or removed from a computing environment using deployment functionality provided by the computing environment (e.g., an installation component of an operation system may provide such deployment functionality). For example, a user may purchase, download, and install an application from an application store accessible to a computing environment. Unfortunately, conventional deployment functionality may constrain the user to sequential deployment due to shortcomings that may arise from limited conflict handling, limited resources, deployment exclusivity, inability to interactively cancel deployment operations, inability to process request from multiple users concurrently, etc. In this way, conventional deployment techniques may degrade a user's experience because of the long delays that may be associated with sequential deployment and/or the limited deployment options that may be provided.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for deploying an application are disclosed herein (e.g., concurrent deployment of one or more applications may be facilitated). It may be appreciated that an application may be deployed in a variety of ways, such as download, installation, update, removal, registration, etc. In one example of deploying an application, an application that is requested for deployment within a computing environment may be identified (e.g., the application may be an oldest entry within a queue, the application may be specified within a registry entry as incomplete from a prior deployment session, etc.). Deployment parameters may be extracted from a manifest (e.g., metadata) associated with the application. It may be appreciated that the manifest may comprise metadata, such as the deployment parameters, describing information associated with a request to deploy the application (e.g., information associated with how the application is to be deployed). For example, the deployment parameters may correspond to a deployment action (e.g., download, install, remove, update, etc.), a target resource (e.g., a storage device, a particular hardware component, and/or other resources that may be utilized during deployment of the application), a file that may be utilized during deployment, a registry entry that may be used during deployment, an identification ID of the application, a version of the application, an application family identification (e.g., the application may be associated with a group of software applications, such as an office productivity software suite), and/or a variety of other information.

A set of deployment rules may be executed upon the deployment parameters to determine whether a conflict (e.g., a potential issue that may arise during concurrent deployment of the application and/or one or more other applications) exists between the deployment parameters associated with the application and a second application being deployed within the computing environment. For example, deployment parameters within the manifest associated with the application may be compared with deployment parameters within a second manifest associated with the second application to detect conflicts (e.g., the conflict may be based upon whether both applications may attempt to access similar resources, files, registry entries, and/or other data during deployment). It may be appreciated that the set of deployment rules may correspond to a variety of rules, such as enforcing a threshold of allowable concurrent deployments, restricting deployment of applications from a similar application family, restricting deployment of applications that may create a conflicting change to the computing environment, restricting deployment of applications that may create a resource exhaustion, restricting deployment of applications that may create a resource conflict, and/or a plethora of other rules. In this way, if no conflict exists, then the application may be concurrently deployed with the second application. It may be appreciated that a variety of applications may be concurrently deployed based upon executing the set of deployment rules.

It may be appreciated that in another example, a deployment schedule may be created based upon the deployment parameters and/or based upon executing the set of deployment rules. For example, one or more applications that may be deployed concurrently may be grouped together for concurrent deployment. In this way, one or more groupings of applications may be determined and/or scheduled for deployment based upon a deployment schedule.

It may be appreciated that the subject matter described herein is not limited to merely instances of concurrent deployment, but may also extend to instances where deployment parameters may be extracted from a manifest, and may be evaluated to determine how to deploy a single application and/or determine how to schedule the application for deployment.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of deploying an application.

FIG. 2 is a flow chart illustrating an exemplary method of deploying an application.

FIG. 3 is a component block diagram illustrating an exemplary system for deploying an application.

FIG. 4 is an illustration of an example of a queue associated with deployment of applications within a computing environment.

FIG. 5 is an illustration of an example of detecting a conflict between concurrent deployment of a word processing application and a spreadsheet application.

FIG. 6 is an illustration of an exemplary computer-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Computing devices, such as smart phones, laptops, desktop computers, terminal servers, and tablets, etc. may comprise computing environments (e.g., a single user or multi-user operating system) that allow users to acquire and/or deploy applications within such computing environments. In this way, a user may download, install, update, remove, register, and/or perform other deployment functionality. Unfortunately, current deployment techniques provide for sequential (e.g., serial) deployment of applications to prevent conflicts and/or errors that may arise from concurrent deployment. Sequential deployment may result in significant delay when deploying more than one application. Additionally, within a multi-user environment, a deployment by a single user may delay deployments from other users because merely a single deployment may be processed at a time.

Accordingly, one or more systems and/or techniques for deploying an application are provided herein. In particular, deployment parameters within a manifest associated with an application that is to be deployed may be compared with deployment parameters within manifests associated with other applications currently being deployed. The comparison may comprise executing a set of deployment rules to determine whether a conflict exists between the deployment parameters from the manifest associated with the application and deployment parameters from manifests associated with the applications currently being deployed. If no conflict exists, (e.g., the execution of the set of deployment rules does not result in a detected conflict) then the application may be concurrently deployed with the other applications currently being deployed. In this way, concurrent deployment of applications may be achieved, which may improve deployment efficiency (e.g., mitigate deployment delays caused by sequential deployment), while mitigating conflicts and/or other issues that may otherwise arise should concurrent deployment be allowed without first executing the set of deployment rules to detect conflicts.

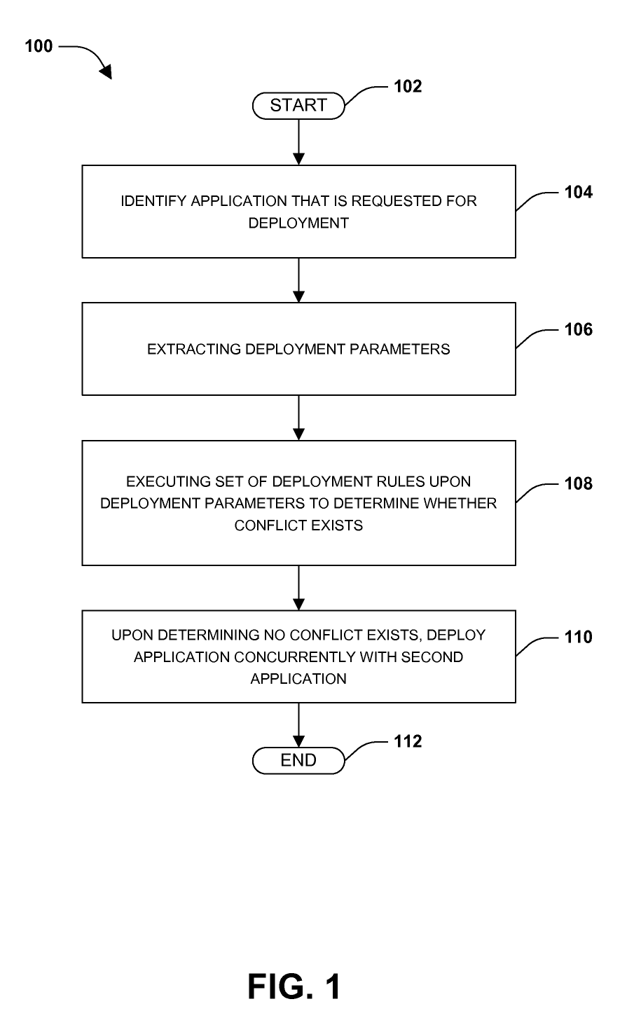

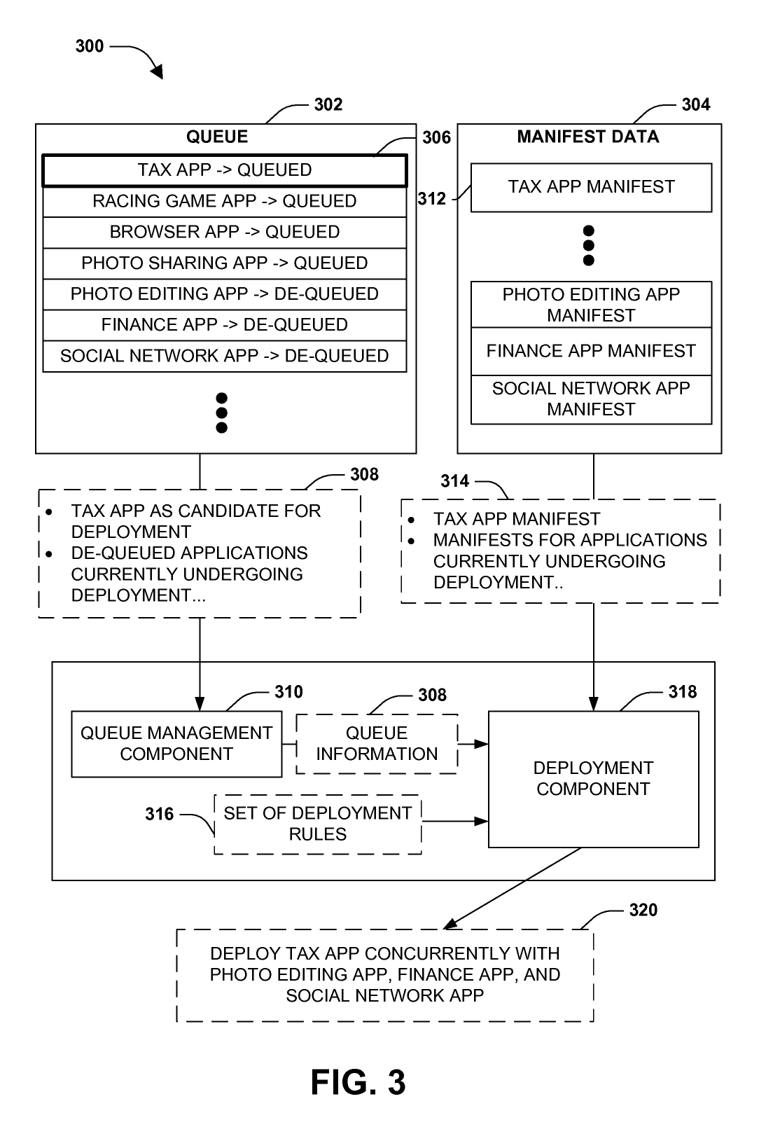

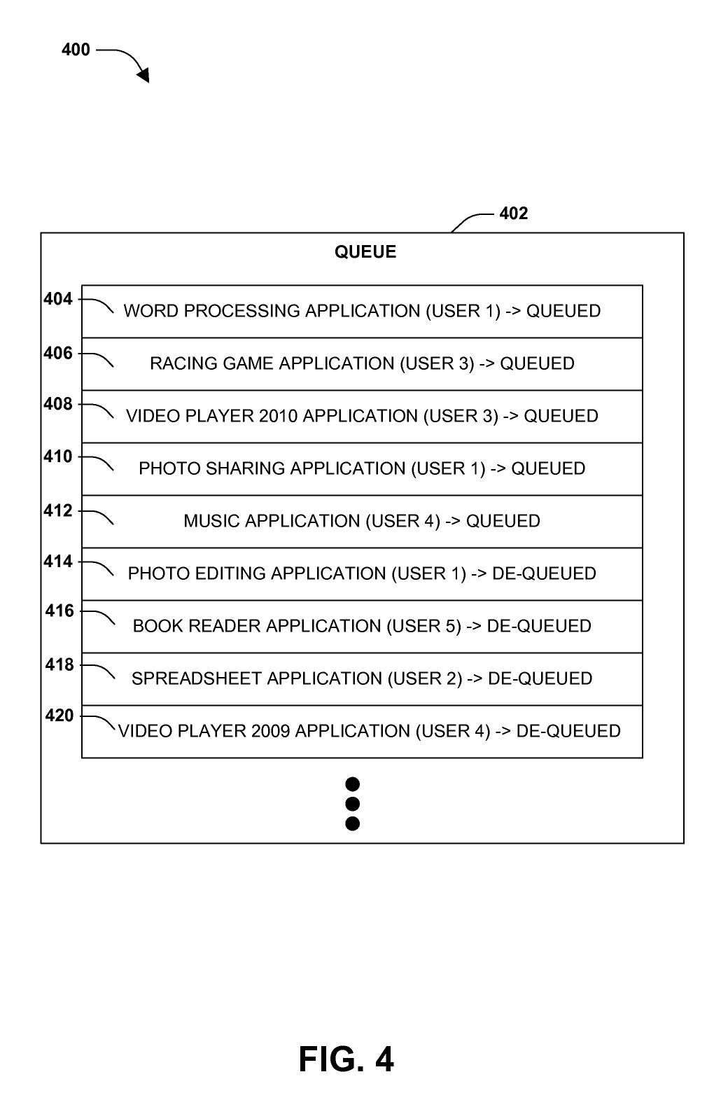

One embodiment of deploying an application is illustrated by an exemplary method 100 in FIG. 1. At 102, the method starts. At 104, an application that is requested for deployment within a computing environment may be identified. In one example, a registry may be searched for one or more deployment requests (e.g., an operating system registry may be utilized to persist deployment requests across computing system reboots, such that an incomplete deployment may be resumed and/or rolled back based upon information stored within the operating system registry). In another example, a deployment request may be received from a user (e.g., a user may request to initiate a download, install, update, and/or removal of the application). In another example, a queue (e.g., queue 302 of FIG. 3 and/or queue 402 of FIG. 4) of deployment requests may be queried to identify the application. The queue may provide additional deployment functionality, such as allowing a user to remove an undeployed application (e.g., a pending, yet unexecuting, application installation) from the queue based upon a deployment cancellation request. The queue may be iteratively traversed (e.g., first in first out order, last in first out order, and/or other queue management/traversal orders/techniques) to identify the application. In this way, the application for deployment may be identified.

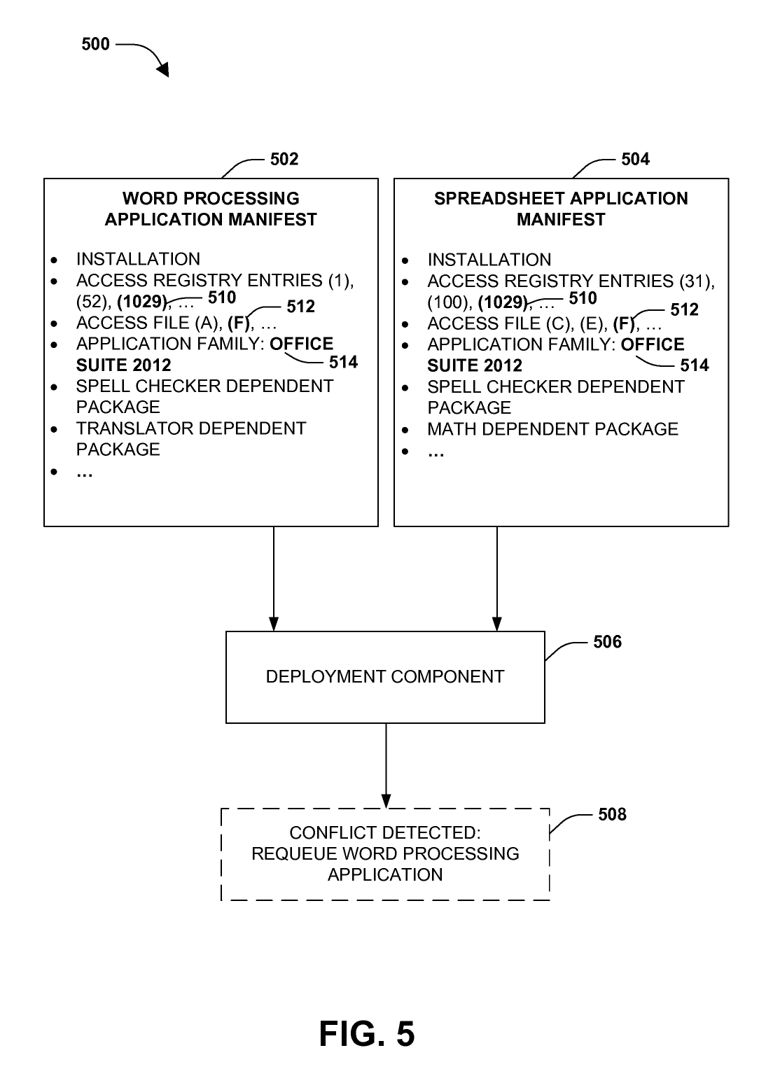

At 106, deployment parameters may be extracted from a manifest (e.g., manifest 502 and/or manifest 504 of FIG. 5) associated with the application. In one example, the manifest may comprise metadata that may be obtained from an application store associated with the application (e.g., a user may have purchased the application from the application store, and may desire to deploy the application). Additionally, an application deployment package comprising data used for deployment may be obtained from the application store (e.g., installation files, removal instructions, download instructions, update files, etc.).

The deployment parameters may describe information associated with the requested deployment. In one example, a deployment parameter may specify a deployment action indicating whether the deployment relates to a download, an installation, a removal, an update, and/or a registration. In another example, a deployment parameter may specify one or more target resources that may be utilized during deployment (e.g., storage space, thread pool information, registry entry information, processor execution information, a number of staging operations, registration of extension points, etc.). In another example, a deployment parameter may specify one or more files that may be utilized during deployment (e.g., application files may be created, modified, and/or deleted during deployment). In another example, a deployment parameter may specify one or more registry entries that may be utilized during deployment (e.g., registry entries may be created, modified, and/or deleted during deployment). In another example, a deployment parameter may specify an identification and/or version of the application (e.g., the version may provide identification for the application, which may be compared with other applications currently deployed to detect potential conflicts from deploying similar applications). In another example, a deployment parameter may specify an application family (e.g., a product family, such as a set of related applications comprising a product in various versions, such as a text editor version 6.5 and a text editor version 7.0, etc.) identification with which the application is associated (e.g., the application may be part of a suite of applications that may share similar application files and/or registry entries, which may cause potential conflicts when two applications from the same application family are deployed concurrently).

At 108, a set of deployment rules may be executed upon the deployment parameters to determine whether a conflict (e.g., a potential issue that may arise during concurrent deployment of the application and/or one or more other applications) exists between the deployment parameters and a second application being deployed within the computing environment (e.g., the set of deployment rules may determine whether concurrent deployment of the application and second application may create a conflict and/or other issue). In one example of a conflict, the conflict may correspond to a conflicting change to the computing environment during deployment of the application and the second application (e.g., a resource access conflict, a file access conflict, a registry access conflict, etc.). In another example of a conflict, the conflict may correspond to a variety of issues that may potentially arise from allowing concurrent deployment of the application and the second application (e.g., an issue may potentially arise if a number of deployed applications is above a threshold of allowable concurrent deployments). In one example of executing the set of deployment rules, the deployment parameters within the manifest of the application may be compared with deployment parameters within a second manifest of the second application to detect conflicts and/or potential issues that may arise from concurrent deployment.

It may be appreciated that the set of deployment rules may comprise a variety of different deployment rules that may be implemented in various ways. In one example, a deployment rule may determine whether a threshold of allowable concurrent deployments has already been met (e.g., a maximum threshold of 8 concurrent deployments may be allowed per computing environment and/or device, and thus the application may be withheld from being deployed if the maximum threshold is already met). In another example, a deployment rule may specify that applications from a similar application family may not be deployed concurrently, unless such applications are deployed for registration. That is, if the application and the second application are from a similar application family and are not being deployed for registration, then deployment of the application may be withheld because a potential conflict may arise (e.g., concurrent deployment of a spreadsheet application and a word processor application from the same office productive suite may result in both applications attempting to access similar files, registry entries, and/or resources during deployment, which may result in a conflict). However, if the application and the second applications are deployed for registration (e.g., registration of the applications with the computing environment, such as informing an operating system about a presence of an already deployed application, etc.), then concurrent deployment may be allowed.

In another example, a deployment rule may specify that applications creating a resource exhaustion during concurrent deployment may not be concurrently deployed (e.g., if concurrent deployment of the application and the second application may result in an exhaustion of storage space and/or processing resources, then deployment of the application may be withheld). For example, an evaluation of the deployment parameters associated with the application and the second application may indicate that concurrent deployment of the applications may result in an exhaustion of storage resources.

In another example, a deployment rule may specify that applications creating a resource conflict during concurrent deployment may not be concurrent deployed (e.g., if concurrent deployment of the application and the second application may result in a resource conflict then deployment of the application may be withheld). For example, deployment parameters associated with the application and the second application may indicate that both applications may access similar files and/or registry entries during deployment, which may result in a conflict (e.g., one application may overwrite data written to a file and/or registry entry by the other application, thus resulting in a loss of data). It may be appreciated that other deployment rules may be executed, such as whether an application requests exclusivity with respect to one or more deployment operations (e.g., a determination may be made as to whether the resource with which exclusivity is requested may be accessed by another application during deployment). Upon determining no conflict exists, the application may be concurrent deployed with the second application, at 110.

In one example, the application may be associated with one or more dependent applications (e.g., a word processing application may be associated with a spell checker application). Accordingly, one or more dependent application packages associated with the application may be identified within the manifest. The set of deployment rules may be executed upon the one or more dependent application packages to determine whether a conflict may arise from concurrent deployment of the dependent applications and one or more currently deployed applications.

It may be appreciated that in one example, the computing environment may comprise a multi-user computing environment (e.g., a terminal server). The multi-user computing environment may allow one or more users to access the multi-user computing environment (e.g., a first user may install a first application, a second user may remove a second application, a third user may execute a third application, etc.). Thus, in one example, the application requested for deployment may correspond to a first user and the second application currently being deployed may correspond to a second user. In this way, the set of deployment rules may be executed to determine whether concurrent deployment of the applications associated with different users may be performed. At 112, the method ends.

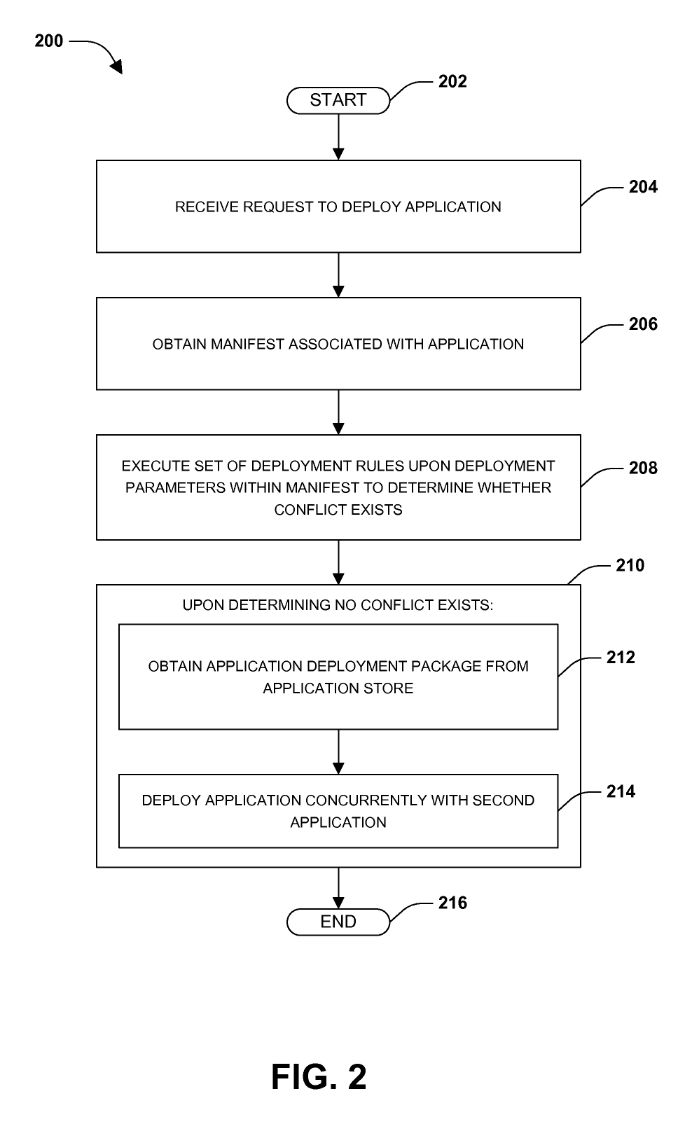

One embodiment of deploying an application is illustrated by an exemplary method 200 in FIG. 2. At 202, the method starts. At 204, a request to deploy an application within a computing environment may be received. The application may be associated with a first user of the computing environment. At 206, a manifest (e.g., metadata) associated with the application may be obtained from an application store, for example, (e.g., and/or one or more other sources associated with at least some aspect of distributing the application).

At 208, a set of deployment rules may be executed upon deployment parameters within the manifest to determine whether a conflict (e.g., a potential issue that may arise during concurrent deployment of the application and/or one or more other applications) exists between the deployment parameters and a second application being deployed by a second user within the computing environment. For example, the set of deployment rules may compare the deployment parameters within the manifest associated with the application with deployment parameters within a second manifest associated with the second application to determine whether a conflict and/or other issues may arise from concurrent deployment. At 210, upon determining no conflict exists, an application deployment package comprising data used for deployment of the application may be obtained from the application store, for example, at 212. The application deployment package may comprise a variety of data, such as installation files, removal instructions, update files, etc. At 214, the application may be concurrently deployed with the second application using the application deployment package. In this way, multiple applications associated with various users may be deployed concurrently in the computing environment, while mitigating instances of conflicts and/or other issues. At 216, the method ends.

FIG. 3 illustrates an example of a system 300 configured for deploying an application. The system 300 may comprise a queue management component 310 and/or a deployment component 318. The queue management component 310 may be configured to identify an application (e.g., tax application 306) that is queued within a queue 302 for deployment within a computing environment. In one example, the queue management component 310 may be configured to iteratively traverse the queue 306 of applications queued for deployment (e.g., status=queued) to identify the application (e.g., the queue management component 310 may iteratively traverse the queue 302 for applications to deploy until a(n optionally set) threshold number of non-conflicting applications are concurrently deployed within the computing environment). For example, the queue management component 310 may identify tax application 306 within the queue 302 based upon a first in first out scheme. In this way, the queue management component 310 may determine queue information 308 comprising the tax application 306 as a candidate for deployment and/or a list of de-queued applications currently undergoing deployment (e.g., a photo editing application, a finance application, social network application, and/or other applications that may be currently undergoing deployment). It may be appreciated that by iteratively traversing the queue, applications down in the queue may be identified for deployment where applications near the top of the queue are not authorized for deployment (e.g., conflict exists) to mitigate a lull in application deployment generally. The queue management component 310 may make the queue information 308 available to the deployment component 318.

The deployment component 318 may be configured to extract deployment parameters from a manifest associated with the application. For example, the deployment component 318 may consult manifest data 304 to retrieve manifest information 314 comprising a tax application manifest 312 corresponding to the tax application 306 and/or other manifests associated with applications currently undergoing deployment (e.g., a photo editing application manifest, a finance application manifest, a social network application manifest, and/or other manifests of applications currently undergoing deployment). The tax application manifest 312 may comprise one or more deployment parameters specifying various information associated with the tax application 306 and/or information associated with the requested deployment of the tax application 306 (e.g., a deployment action, target resources that are to be utilized during deployment, files that are to be utilized during deployment, registry entries that are to be utilized during deployment, identification of the application, a version of the application, an application family identification, and/or a variety of other information).

The deployment component 318 may be configured to execute a set of deployment rules 316 upon the deployment parameters to determine whether a conflict (e.g., a resource access conflict, a file access conflict, a registry access conflict, a conflicting change of the computing environment that may arise from concurrent deployment, and/or other issues that may potentially arise from concurrent deployment of the tax application 306 with one or more currently deployed applications) exists between the deployment parameters and a second application being deployed within the computing environment. For example, execution of the set of deployment rules 316 may compare deployment parameters extracted from the tax application manifest 312 with deployment parameters associated with the photo editing application manifest, the finance application manifest, the social network application manifest, and/or manifests of other currently deployed applications.

It may be appreciated that the set of deployment rules 316 may comprise a variety of deployment rules that may detect various potential conflicts and/or issues that may arise from concurrent deployment of the application with one or more currently deployed applications (e.g., whether concurrent deployment may result in a resource conflict, resource exhaustion, a conflicting change to the computing environment, a violation of a maximum threshold of allowable concurrent deployments, etc.). In one example of executing the set of deployment rules, one or more dependent application packages associated with the application may be identified within the manifest (e.g., the tax application manifest 312 may specify that a calculator application may be associated with the tax application 306). Thus, the set of deployment rules 316 may be executed upon the one or more dependent application packages to detect whether a conflict may arise, which may result in the deployment component 318 refraining from deploying the tax application 306.

Upon determining no conflict exists, the deployment component 318 may be configured to deploy the application concurrently with the second application. For example, the tax application 306 may be deployed 320 concurrently with the photo editing application, the finance application, and/or the social network application.

FIG. 4 illustrates an example 400 of a queue 402 associated with deployment of applications within a computing environment. The queue 402 may comprise one or more applications that are requested for deployment (e.g., status=queued) and/or one or more applications that are currently undergoing deployment (e.g., status=de-queued). The queue 402 may be iteratively traversed to determine whether one or more applications queued for deployment may be deployed concurrently with applications currently undergoing deployment without create a conflict and/or other potential issues.

In one example, a word processing application 404 queued for deployment may be determined as conflicting (e.g., a resource conflict, a file access conflict, an exclusive write access to a file, etc.) with a spreadsheet application 418 currently undergoing deployment because both applications are part of a similar application family (e.g., an office productivity suite) and are not associated with a registration deployment action. Thus, the word processing application 404 may not be concurrently deployed with the spreadsheet application 418. In another example, a racing game application 406 queued for deployment may be deploy concurrently with applications currently undergoing deployment because no conflict may arise from deploying the racing game application 406 with the applications currently undergoing deployment (e.g., a photo editing application 414, a book reader application 416, the spreadsheet application 418, a video player 2009 application 420, and/or other applications).

In another example, a video player 2010 application 408 queued for deployment may be determined as conflicting with the video player 2009 application 420 currently undergoing deployment because concurrent deployment of both applications may result in a conflict, such as a resource conflict, a file access conflict, a registry access conflict, etc. (e.g., if video player 2009 application 420 is currently being installed and video player 2010 application 408 is to be removed, then allowing concurrent installation and removal may result in inconsistent results and/or data loss because data installed by video player 2009 application 420 may be removed during the removal of video player 2010 application 408).

In another example, a photo sharing application 410 queued for deployment may share a similar application family (e.g., a multimedia application suite) as photo editing application 414 currently undergoing deployment. However, the photo sharing application 410 may be concurrently deployed with the photo editing application 414 because both deployments may be registration deployments, which may not result in a conflict and/or other issues. In another example, a music application 412 queued for deployment may not be deployed because a threshold number of allowable concurrent deployments may have been reached. In this way, applications associated with various users may be concurrently deployed within the computing environment from the queue 402. It may be appreciated that establishing a threshold number of allowable concurrent deployments is optional, and thus this may be regarded as an optionally set threshold number of non-conflicting applications.

FIG. 5 illustrates an example 500 of detecting a conflict between concurrent deployment of a word processing application and a spreadsheet application. The spreadsheet application may be currently undergoing deployment within a computing environment by a deployment component 506 (e.g., currently being installed within the computing environment). The deployment component 506 may identify the word processing application as being requested for deployment within the computing environment.

The deployment component 506 may compare deployment parameters within a word processing application manifest 502 associated with the word processing application and deployment parameters within a spreadsheet application manifest 504 associated with the spreadsheet application to detect conflicts (e.g., potential issues that may arise if the word processing application and the spreadsheet application were concurrently deployed). In particular, the deployment component 506 may execute a set of deployment rules upon the deployment parameters within the word processing application manifest 502 and the spreadsheet application manifest 504 to detect a conflict. In one example, the deployment component 506 may determine that a registry access conflict may arise from concurrent deployment because both the word processing application and the spreadsheet application may access registry entry (1029) 510 during deployment. In another example, the deployment component 506 may determine that a file access conflict may arise from concurrent deployment because both the word processing application and the spreadsheet application may access file (F) 512 during deployment. In another example, the deployment component 506 may determine that an application family conflict may arise from concurrent deployment because both the processing application and the spreadsheet application are associated with the office suite 2012 514, and are not both being deployed for registration. In this way, the deployment component 506 may detect a conflict 508 and/or re-queue the word processing application so that the word processing application is not concurrently deployed with the spreadsheet application.

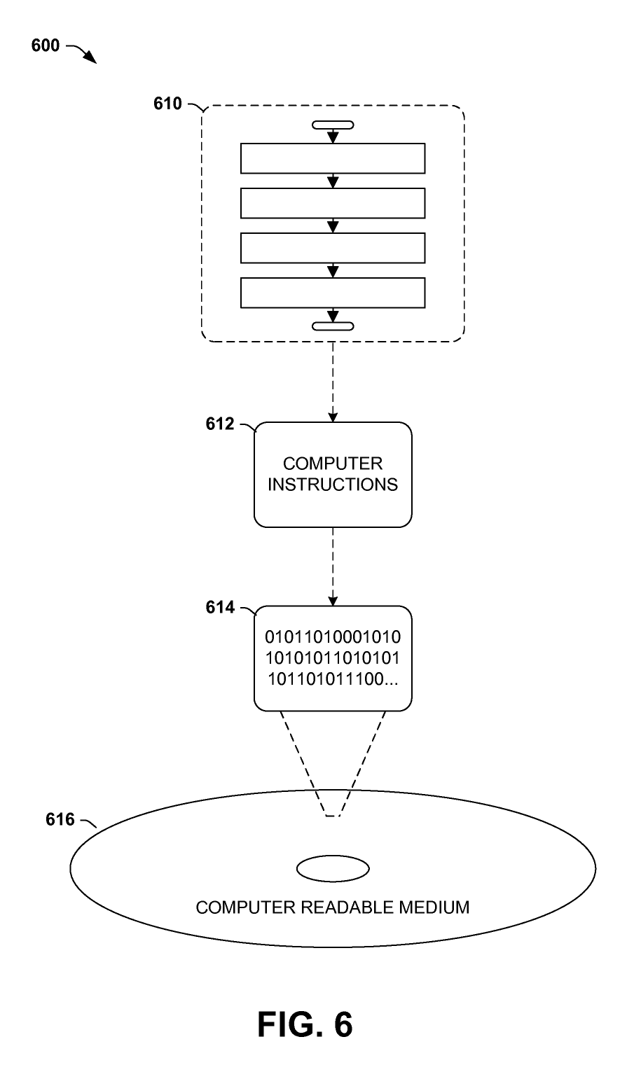

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 616 (e.g., a CD-R, DVD-R, a solid-state (e.g., flash) storage device, or a platter of a hard disk drive), on which is encoded computer-readable data 614. This computer-readable data 614 in turn comprises a set of computer instructions 612 configured to operate according to one or more of the principles set forth herein. In one such embodiment 600, the processor-executable computer instructions 612 may be configured to perform a method 610, such as at least some of the exemplary method 100 of FIG. 1 and/or at least some of exemplary method 200 of FIG. 2, for example. In another such embodiment, the processor-executable instructions 612 may be configured to implement a system, such as at least some of the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

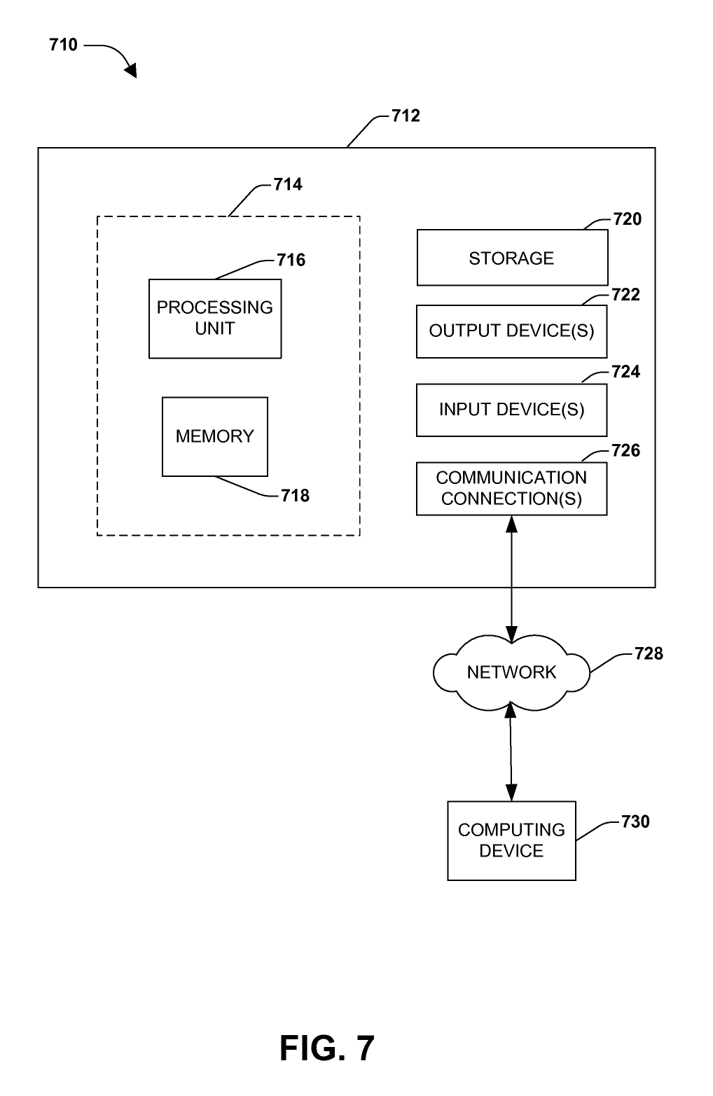

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for deploying an application, comprising:
identifying an application that is requested for deployment within a computing environment;
extracting deployment parameters from a manifest associated with the application;
executing a set of deployment rules upon the deployment parameters to determine whether a conflict exists between the deployment parameters and a second application being deployed within the computing environment; and
upon determining no conflict exists, deploying the application concurrently with the second application.

2. The method of claim 1, comprising:
iteratively traversing a queue of applications queued for deployment to deploy an optionally set threshold number of non-conflicting applications within the computing environment concurrently.

3. The method of claim 1, the executing a set of deployment rules comprising:
comparing the deployment parameters within the manifest of the first application with deployment parameters within a second manifest of the second application.

4. The method of claim 1, the conflict corresponding to:
a conflicting change to the computing environment during deployment of the application and the second application, the conflicting change associated with at least one of a resource access conflict, a file access conflict, and a registry access conflict.

5. The method of claim 1, the set of deployment rules corresponding to at least one of:
a threshold of allowable concurrent deployments;
no concurrent deployment of applications from a similar application family, unless respective applications are deployed for registration;
no concurrent deployment of applications creating a conflicting change to the computing environment;
no concurrent deployment of applications creating a resource exhaustion; and
no concurrent deployment of applications creating a resource conflict.

6. The method of claim 1, the executing a set of deployment rules comprising:
identifying, within the manifest, one or more dependent application packages associated with the application; and
executing the set of deployment rules upon the one or more dependent application packages.

7. The method of claim 1, the deployment parameters within the manifest comprising at least one of:
a deployment action corresponding to at least one of: a download, an installation, a removal, and an update;
one or more target resources to be utilized during deployment;
one or more files to be utilized during deployment;
one or more registry entries to be utilized during deployment;
identification of the application;
a version of the application; and
an application family identification with which the application is associated.

8. The method of claim 1, comprising:
obtaining the manifest from an application store; and
obtaining an application deployment package from the application store, the application deployment package comprising data used for deployment.

9. The method of claim 1, the computing environment comprising a multi-user environment, the application associated with a first user and the second application associated with a second user.

10. The method of claim 2, comprising:
removing an undeployed application from the queue based upon a deployment cancellation request.

11. The method of claim 2, comprising:
persisting the queue during a reboot of the computing environment.

12. The method of claim 12, comprising at least one of:
resuming the deployment of the application upon reboot; and
rolling back the deployment of the application upon reboot.

13. A system for deploying an application, comprising:
a queue management component configured to:
identify an application that is queued within a queue for deployment within a computing environment; and
a deployment component configured to:
extract deployment parameters from a manifest associated with the application;
execute a set of deployment rules upon the deployment parameters to determine whether a conflict exists between the deployment parameters and a second application being deployed within the computing environment; and
upon determining no conflict exists, deploy the application concurrently with the second application.

14. The system of claim 13, the queue management component configured to:
iteratively traverse the queue of applications queued for deployment to deploy an optionally set threshold number of non-conflicting applications within the computing environment concurrently.

15. The system of claim 13, the computing environment comprising a multi-user environment, the application associated with a first user and the second application associated with a second user.

16. The system of claim 13, the conflict corresponding to:
a conflicting change to the computing environment during deployment of the application and the second application, the conflicting change associated with at least one of a resource access conflict, a file access conflict, and a registry access conflict.

17. The system of claim 13, the set of deployment rules corresponding to at least one of:
a threshold of allowable concurrent deployments;
no concurrent deployment of applications from a similar application family, unless respective applications are deployed for registration; and
no concurrent deployment of applications creating a conflicting change to the computing environment;
no concurrent deployment of applications creating a resource exhaustion; and
no concurrent deployment of applications creating a resource conflict.

18. The system of claim 13, the executing a set of deployment rules comprising:
identifying, within the manifest, one or more dependent application packages associated with the application; and
executing the set of deployment rules upon the one or more dependent application packages.

19. The system of claim 13, the deployment parameters within the manifest comprising at least one of:
a deployment action corresponding to at least one of: a download, an installation, a removal, and an update;
one or more target resources that are be utilized during deployment;
one or more files that are be utilized during deployment;
one or more registry entries that are be utilized during deployment;
identification of the application;
a version of the application; and
an application family identification with which the application is associated.

20. A computer readable medium comprising computer executable instructions that when executed via a processing unit perform a method for deploying an application comprising:
receiving a request to deploy an application associated with a first user within a computing environment;
obtaining a manifest associated with the application from an application store;
executing a set of deployment rules upon deployment parameters within the manifest to determine whether a conflict exists between the deployment parameters and a second application being deployed by a second user within the computing environment, the executing comprising comparing the deployment parameters within the manifest associated with the application with deployment parameters within a second manifest of the second application; and
upon determining no conflict exists:
obtaining an application deployment package from the application store, the application deployment package comprising data used for deployment of the application; and
deploying the application concurrently with the second application using the application deployment package.
